(19) United States
(12) Patent Application Publication
(10) Pub. No.: US 2006/0284514 A1
(43) Pub. Date: Dec. 21, 2006

(54) Actuator having vertical comb electrode structure

(75) Inventors: Young-chul Ko, Yongin-si (KR); Jin-woo Cho, Seongnam-si (KR)

Correspondence Address: BUCHANAN, INGERSOLL & ROONEY PC, POST OFFICE BOX 1404, ALEXANDRIA, VA, 22313-1404, US

(73) Assignee: Samsung Electronics Co., Ltd., Suwon-si (KR)

(21) Appl. No.: 11/341,460

(22) Filed: Jan. 30, 2006

(30) Foreign Application Priority Data
Jun. 15, 2005 (KR) 10-2005-0051265

(51) Int. Cl. G02B 26/08; G02B 26/00; H02N 1/00

(52) U.S. Cl. 310/309; 359/225; 359/291

(57) ABSTRACT

An actuator having a vertical comb electrode structure is provided. The actuator includes: a stage seesawing in a first direction; a support unit supporting the seesawing motion of the stage; and a stage driving unit including vertical driving comb electrodes extending outward from opposite sides of the stage in the first direction, and vertical fixed comb electrodes disposed on a substrate to alternate with the driving comb electrodes, wherein the fixed comb electrodes include first fixed comb electrodes lower than the driving comb electrodes, insulation layers formed on the first fixed comb electrodes, and second fixed comb electrodes formed on the insulation layers to be higher than bottom surfaces of the driving comb electrodes.

### CROSS-REFERENCE TO RELATED PATENT APPLICATION

This application claims the benefit of Korean Patent Application No. 10-2005-0051265, filed on Jun. 15, 2005, in the Korean Intellectual Property Office, the disclosure of which is incorporated herein in its entirety by reference.

### BACKGROUND OF THE DISCLOSURE

1. Field of the Disclosure

The present disclosure relates to a micro-electro-mechanical system (MEMS) actuator having a vertical comb electrode structure, and more particularly, to an optical scanner having a vertical comb electrode structure, which can be easily manufactured with fixed comb electrodes and driving comb electrodes overlapping with each other.

2. Description of the Related Art

Actuators having a vertical comb electrode structure can be used as optical scanners for large displays to scan a laser beam. The driving speed of an actuator used as an optical scanner is related to the resolution of a display device, and the driving angle of the actuator is related to the screen size of the display device. That is, as the driving speed of a micro mirror increases, the resolution can be improved. Also, as the driving angle of the micro mirror increases, the screen size of the display device can be increased. Accordingly, in order to realize large display devices with high resolution, actuators need to operate at high speed and have a high driving angle.

Optical scanners used for vertical scanning need to operate linearly.

FIG. 1 is a plan view of a conventional actuator. FIG. 2 is a cross-sectional view taken along line II-II of FIG. 1. Referring to FIGS. 1 and 2, a stage 1 is suspended above a substrate 5 made of Pyrex glass or the like by torsion springs 2 and anchors 6 which support both sides of the stage 1. A plurality of driving comb electrodes 3 extend a predetermined distance from opposite sides of the stage 1 and are parallel to one another. A plurality of fixed comb electrodes 4 are formed on a top surface of the substrate 5 and alternate with the driving comb electrodes 3.

The stage 1 seesaws due to an electrostatic force between the driving comb electrodes 3 and the fixed comb electrodes 4. For example, if a predetermined voltage Vd₁ is applied to the fixed comb electrodes 4 disposed on the left side of the torsion springs 2, an electrostatic force is generated between the driving comb electrodes 3 and the fixed comb electrodes 4 to drive the driving comb electrodes 3, thereby moving the stage 1 leftward. If a predetermined voltage Vd₂ is applied to the fixed comb electrodes 4 disposed on the right side of the torsion springs 2, an attractive force is generated between the driving comb electrodes 3 and the fixed comb electrodes 4, thereby moving the stage 1 to the right. The stage 1 returns to its original position due to the restoring force of the torsion springs 2. The stage 1 can seesaw by repeatedly and alternately applying a driving voltage to the fixed comb electrodes on the left side and the right side to alternately generate an electromagnetic force on the left and right sides of the stage 1.

Referring to FIG. 2, since the driving comb electrodes 3 and the fixed comb electrodes 4 do not overlap each other in a vertical plane, a vertical comb electrode structure can be easily manufactured by forming the fixed comb electrodes 4 as a lower conductive layer of a silicon-on-insulator (SOI) substrate, forming the driving comb electrodes 3 as an upper conductive layer of the SOI substrate, and etching an insulation layer between the lower conductive layer and the upper conductive layer. However, when the SOI substrate has an insulation layer with a thickness of 2 μm, a driving force is reduced and linearity is degraded as can be seen from FIG. 3. Such a reduction in the driving force as shown in FIG. 3 is caused by a gap between the driving comb electrodes 3 and the fixed comb electrodes 4.

Moreover, when the driving comb electrodes 3 are manufactured, notching occurs such that lower portions of the driving comb electrodes 3 are etched, thereby widening the gap between the fixed comb electrodes 4 and the driving comb electrodes 3 in a vertical plane. As a result, the conventional vertical comb electrode structure with the notching has a low driving force with poor linearity.

### SUMMARY OF THE DISCLOSURE

The present invention may provide an actuator having a vertical comb electrode structure which can be easily manufactured using a silicon-on-insulator (SOI) substrate. The actuator has an improved driving force since additional electrodes are formed in an area where driving comb electrodes and fixed comb electrodes overlap each other in the vertical plane.

According to an aspect of the present invention, there may be provided an actuator having a vertical comb electrode structure, the actuator comprising: a stage seesawing in a first direction; a support unit supporting the seesawing motion of the stage; and a stage driving unit including vertical driving comb electrodes extending outward from opposite sides of the stage in the first direction, and vertical fixed comb electrodes disposed on a substrate to alternate with the driving comb electrodes, wherein the fixed comb electrodes include first fixed comb electrodes lower than the driving comb electrodes, insulation layers formed on the first fixed comb electrodes, and second fixed comb electrodes formed on the insulation layers to be higher than bottom surfaces of the driving comb electrodes.

Top surfaces of the fixed comb electrodes may be lower than top surfaces of the driving comb electrodes.

The support unit may comprise: a pair of torsion springs extending from opposite sides of the stage in a second direction perpendicular to the first direction; and a fixed frame fixing one end of each of the torsion springs to suspend the torsion springs above the substrate.

The same voltage may be applied to the first fixed comb electrodes and the second fixed comb electrodes.

The driving comb electrodes and the second fixed comb electrodes may be manufactured as a first conductive layer of a silicon-on-insulator (SOI) substrate, the first fixed comb electrodes may be manufactured as a second conductive layer of the SOI substrate, and the SOI substrate may further comprise an insulation layer interposed between the first conductive layer and the second conductive layer.

According to another aspect of the present invention, there may be provided an actuator having a vertical comb electrode structure, the actuator comprising: a stage suspended above a substrate and seesawing in a first direction; a support unit supporting the seesawing motion of the stage; and a stage driving unit including vertical driving comb electrodes extending outward from opposite sides of the stage in the first direction, and vertical fixed comb electrodes formed on the substrate to alternate with the driving comb electrodes, wherein the driving comb electrodes include first driving comb electrodes higher than the fixed comb electrodes, insulation layers formed on bottom surfaces of the first driving comb electrodes, and second driving comb electrodes formed on the insulation layers to be lower than top surfaces of the fixed comb electrodes.

According to still another aspect of the present invention, there may be provided an actuator having a vertical comb electrode structure, the actuator comprising: a stage seesawing in a first direction; a first support unit supporting the stage; a stage driving unit including first driving comb electrodes extending outward from opposite sides of the stage in the first direction, and first fixed comb electrodes formed on the first support unit facing the first driving comb electrodes to alternate with the first driving comb electrodes; a second support unit supporting the first support unit so that the first support unit can seesaw in a second direction perpendicular to the first direction; and a first support unit driving unit including second driving comb electrodes formed at the first support unit, and second fixed comb electrodes corresponding to the second driving comb electrodes, wherein the second fixed comb electrodes include third fixed comb electrodes lower than the second driving comb electrodes, insulation layers formed on the third fixed comb electrodes, and fourth fixed comb electrodes formed on the insulation layers to be higher than bottom surfaces of the second driving comb electrodes.

The first fixed comb electrodes may include fifth fixed comb electrodes lower than the first driving comb electrodes, insulation layers formed on the fifth fixed comb electrodes, and sixth fixed comb electrodes formed on the insulation layers to be higher than bottom surfaces of the first driving comb electrodes.

According to yet another aspect of the present invention, there is provided an actuator having a vertical comb electrode structure, the actuator comprising: a stage seesawing in a first direction; a first support unit supporting the stage; a stage driving unit including first driving comb electrodes extending outward extending from opposite sides of the stage in the first direction, and first fixed comb electrodes formed on the first support unit facing the first driving comb electrodes to alternate with the first driving comb electrodes; a second support unit supporting the first support unit so that the first support unit can seesaw in a second direction perpendicular to the first direction; and a first support unit driving unit including second driving comb electrodes formed at the first support unit, and second fixed comb electrodes corresponding to the second driving comb electrodes, wherein the second driving comb electrodes include third driving comb electrodes higher than the second fixed comb electrodes, insulation layers formed on bottom surfaces of the third driving comb electrodes, and fourth driving comb electrodes formed on the insulation layers to be lower than top surfaces of the second fixed comb electrodes.

### BRIEF DESCRIPTION OF THE DRAWINGS

The above and other features and advantages of the present invention are described in detailed exemplary embodiments thereof with reference to the attached drawings in which:

FIG. 1 is a plan view of a conventional actuator with a vertical comb electrode structure;

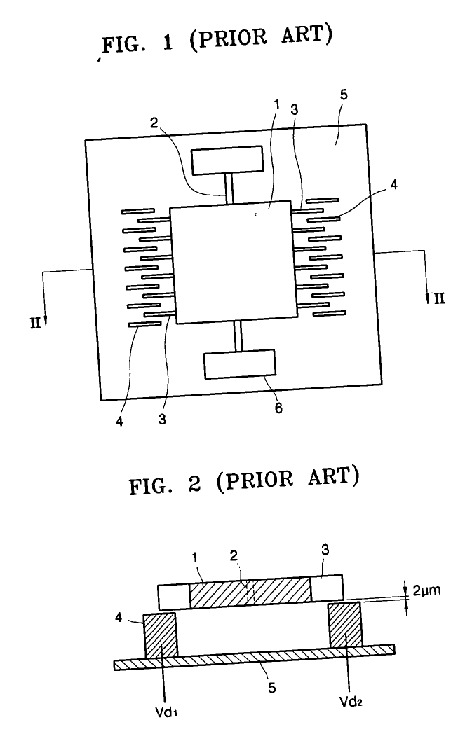

FIG. 2 is a cross-sectional view taken along line II-II of FIG. 1;

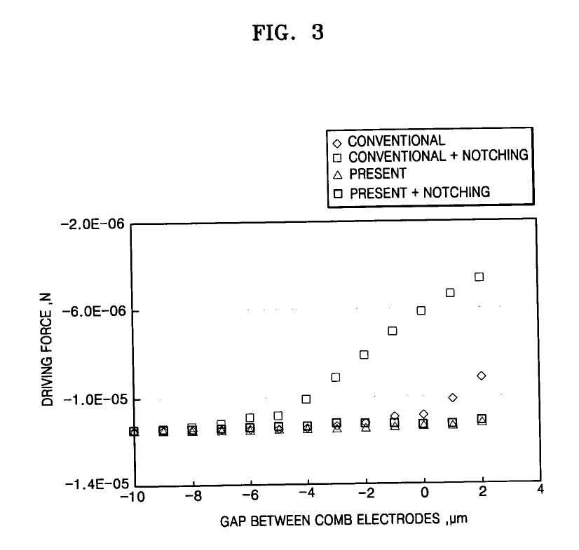

FIG. 3 is a graph illustrating a driving force according to a gap between driving comb electrodes and fixed comb electrodes of the actuator;

FIG. 4 is a perspective view of an actuator according to an embodiment of the present invention;

FIG. 5 is a plan view of the actuator of FIG. 4;

FIG. 6 is a cross-sectional view taken along line VI-VI of FIG. 5;

FIGS. 7A through 7C illustrate electric fields between driving comb electrodes and fixed comb electrodes when a driving voltage of 300 V is applied to a conventional actuator and the actuator of FIG. 4;

FIGS. 8A through 8I are cross-sectional views illustrating a method of manufacturing the actuator of FIG. 4;

FIG. 9 is a cross-sectional view of an actuator according to another embodiment of the present invention;

FIG. 10 is a perspective view of an actuator according to still another embodiment of the present invention;

FIG. 11 is a plan view of the actuator of FIG. 10; and

FIG. 12 is a cross-sectional view taken along line XII-XII of FIG. 11.

### DETAILED DESCRIPTION OF EXEMPLARY EMBODIMENTS

The present invention will now be described more fully with reference to the accompanying drawings, in which exemplary embodiments of the invention are shown. In the following description, the sizes of constituent elements shown in the drawings may be exaggerated, if needed, or elements may be omitted for a better understanding thereof. However, such illustrations do not limit the scope of the technical concept of the present invention.

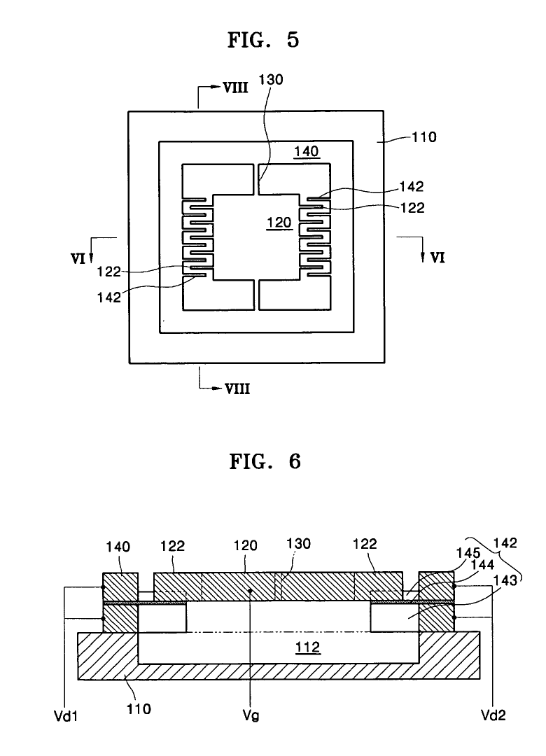

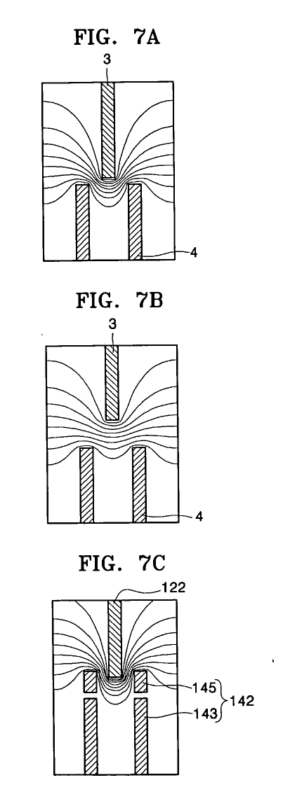

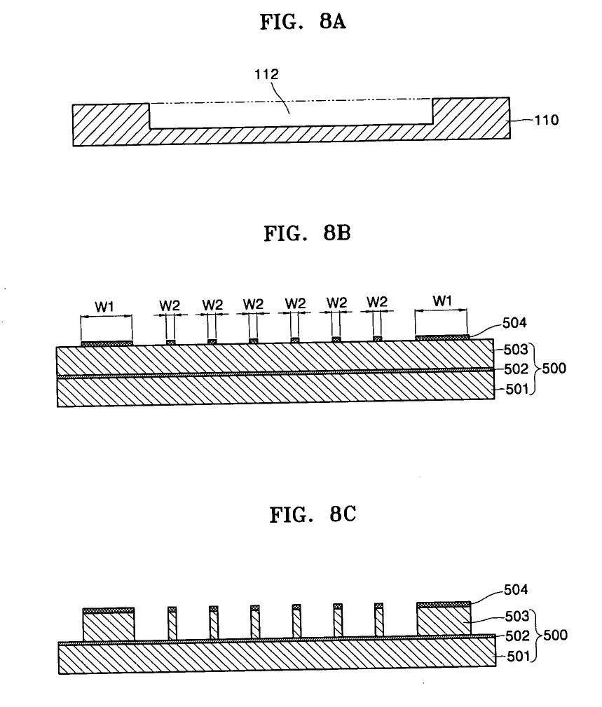

FIG. 4 is a perspective view of an actuator according to an embodiment of the present invention. FIG. 5 is a plan view of the actuator of FIG. 4. FIG. 6 is a cross-sectional view taken along line VI-VI of FIG. 5.

Referring to FIGS. 4 through 6, a stage 120 is suspended above a substrate 110 made of Pyrex glass or the like by a support unit that supports both sides of the stage 120. The support unit includes torsion springs 130 connected to centers of opposite sides of the stage 120 to support a seesawing motion of the stage 120, and a rectangular fixed frame 140 supporting the torsion springs 130 so that the torsion springs 130 can be suspended above the substrate 110.

A plurality of parallel driving comb electrodes 122 extend a predetermined distance from opposite sides of the stage 110. Fixed comb electrodes 142 are formed at the fixed frame 140 and alternate with the driving comb electrodes 122. A space 112 for pivoting the driving comb electrodes 122 is formed in the substrate 110.

The fixed comb electrodes 142 include first fixed comb electrodes 143 at a lower height than the driving comb electrodes 122, insulation layers 144 formed on the first fixed comb electrodes 143, and second fixed comb electrodes 145 at a higher height than bottom surfaces of the driving comb electrodes 122. Top surfaces of the second fixed comb electrodes 145 are lower than top surfaces of the driving comb electrodes 122. The same voltage is applied to the first fixed comb electrodes 143 and the second fixed comb electrodes 145.

The stage 110, the torsion springs 130, the driving comb electrodes 122, and the second fixed comb electrodes 145 may be formed as an upper conductive layer of one silicon-one-insulator (SOI) substrate, and the first fixed comb electrodes 143 may be formed as a lower conductive layer of the SOI substrate. The SOI substrate includes doped polysilicon layers and an insulation layer, e.g., an SiO₂ layer, between the polysilicon layers.

The top surfaces of the second fixed comb electrodes 145 are higher than the bottom surfaces of the driving comb electrodes 122. Even if the bottom surfaces of the driving comb electrodes 122 are removed due to notching, the fixed comb electrodes 142 and the driving comb electrodes 122 can overlap each other in a vertical plane by increasing the height of the second fixed comb electrodes 145.

The operation of the actuator of FIG. 4 will now be explained in further detail.

When a predetermined voltage, for example, a ground voltage Vg, is applied to the driving comb electrodes 122, if the same voltage Vd1 is applied to the first fixed comb electrodes 143 and the second fixed comb electrodes 145 on the left side in FIG. 6, an electrostatic force is generated between the driving comb electrodes 122 and the fixed comb electrodes 142 to drive the driving comb electrodes 122, thereby moving the stage 120 to the left. If a predetermined voltage Vd2 is applied to the fixed comb electrodes 142 on the right side in FIG. 6, an attractive force is generated between the driving comb electrodes 122 and the fixed comb electrodes 142, thereby moving the stage 120 to the right. The stage 120 returns to its original position due to the restoring force of the torsion springs 130. The stage 120 can seesaw by alternately and repeatedly applying a driving voltage to the fixed comb electrodes 142 on the left side and the right side to alternately generate an electrostatic force on the left and right sides of the stage.

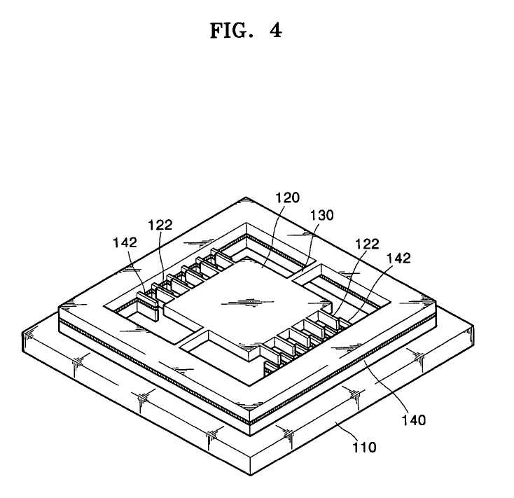

Since the fixed comb electrodes 142 and the driving comb electrodes 122 of the actuator of FIG. 4 vertically overlap each other, regardless of whether the bottom surfaces of the driving comb electrodes 122 are notched, a driving force is improved and a linearity is increased as shown in FIG. 3 with respect to the conventional actuator.

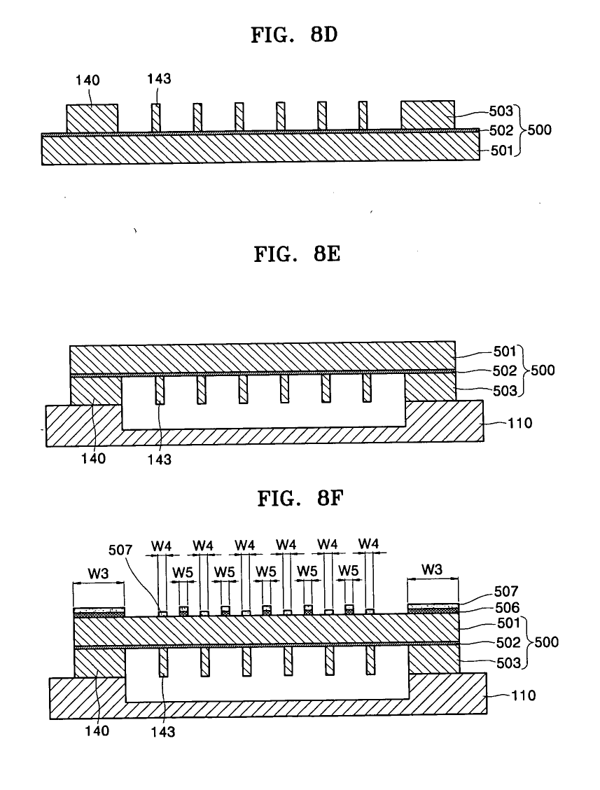

FIGS. 7A through 7C illustrate electric fields between driving comb electrodes and fixed comb electrodes when a driving voltage of 300 V is applied to a conventional actuator and the actuator of FIG. 4.

Referring to FIG. 7A illustrating a conventional actuator in which a gap between fixed comb electrodes 4 and driving comb electrodes 3 is 2 μm, a space between equipotential lines is large, and a driving force obtained by simulation is 9.14 μN.

Referring to FIG. 7B illustrating a conventional actuator in which notching occurs, when a gap between the fixed comb electrodes 4 and the driving comb electrodes 3 is 12 μm, a space between equipotential lines is larger than that when the gap is 2 μm, and a driving force obtained by simulation is 3.6 μN, which is lower than that when the gap is 2 μm.

Referring to FIG. 7C illustrating the actuator of FIG. 4, although the driving comb electrodes 122 are notched by 10 μm, since the second fixed comb electrodes 145 have a height of 12 μm, the fixed comb electrodes 142 and the driving comb electrodes 122 overlap each other. A space between equipotential lines formed between the driving comb electrodes 122 and the fixed comb electrodes 142 is small, and a driving force obtained by simulation is 11.15 μN.

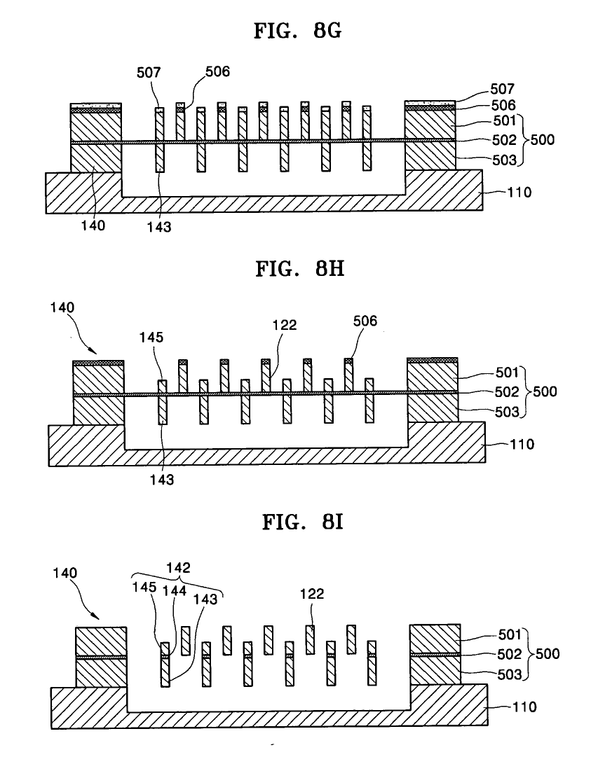

A method of manufacturing the actuator of FIG. 4 will be explained below. FIGS. 8A through 8I are cross-sectional views taken along line VIII-VIII of FIG. 5 illustrating a method of manufacturing the actuator of FIG. 4. Reference numerals identical to those in FIGS. 4 through 6 denote like elements.

Referring to FIG. 8A, Pyrex glass 110 with a thickness of 400 μm is prepared, and is wet etched to a depth of approximately 200 μm to form a driving space 112.

Referring to FIG. 8B, an SOI substrate 500 in which an SiO₂ insulation layer 502 with a thickness of 2 μm is formed as an etch stop layer between a first silicon layer 501 and a second silicon layer 503 is prepared. A photoresist mask 504 having a predetermined shape is formed on the second silicon layer 503. Portions of the second silicon layer 503 covered by the photoresist mask 504 include a fixed frame portion W1 and first fixed comb electrode portions W2.

Referring to FIG. 8C, portions of the second silicon layer 503 not covered by the photoresist mask 504 are etched using an inductively coupled plasma reactive ion etching (ICPRIE) method to expose the insulation layer 502 through exposed areas of the photoresist mask 504. After etching is completed, the photoresist mask 504 is removed by stripping.

Referring to FIG. 8D, a fixed frame 140 and first fixed comb electrodes 143 are formed on the insulation layer 502.

Referring to FIG. 8E, the SOI substrate 500 with the etched second silicon layer 503 is bonded to the glass substrate 110. Anodic bonding is used, and the second silicon layer 503 contacts the glass substrate 110. Subsequently, a top surface of the first silicon layer 501 may be ground to a thickness of approximately 70 μm using a chemical mechanical polishing (CMP) method.

Referring to FIG. 8F, a first mask 506 having a predetermined shape is formed on the first silicon layer 501. Portions of the first silicon layer 501 covered by the first mask 506 include a fixed frame portion W3, driving comb electrode portions W5, a stage portion (not shown), and torsion spring portions (not shown).

A second mask 507 is formed on the fixed frame portion W3, the driving comb electrode portions W5, the stage portion, the torsion spring portions, and the second fixed comb electrode portions W4. The first mask 506 and the second mask 507 are selectively etched.

Referring to FIG. 8G, portions of the first silicon layer 501 not covered by the masks 506 and 507 are etched using ICPRIE to expose the insulation layer 502 through exposed areas of the masks 506 and 507.

Referring to FIG. 8H, the second mask 507 is removed, and then top portions of the second fixed comb electrode portions W4 are etched.

Referring to FIG. 8I, the exposed insulation layer 502 is removed, and then the first mask 506 is removed.

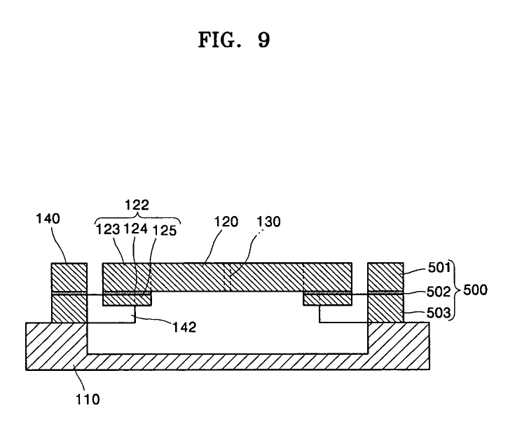

FIG. 9 is a cross-sectional view of an actuator which can act as an optical scanner, according to another embodiment of the present invention. Reference numerals identical to those in FIGS. 4 through 6 denote like elements, and a detailed description of the elements will not be repeated.

Referring to FIG. 9, fixed comb electrodes 142 are formed on a first conductive layer 501 of an SOI substrate, and driving comb electrodes 122 include first driving comb electrodes 123 formed on a second conductive layer 503, insulation layers 124 formed on the first driving comb electrodes 123, and second driving comb electrodes 125 formed on the insulation layers 124. Since the driving comb electrodes 142 and the fixed comb electrodes 122 vertically overlap each other, a driving force with linearity is increased as described above with reference to FIG. 3.

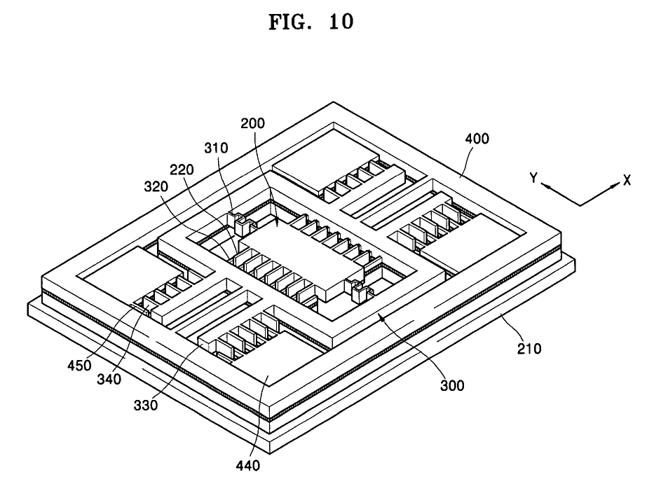

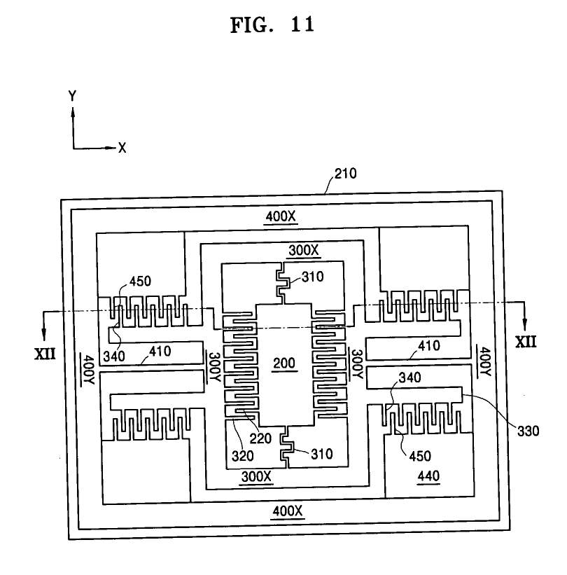

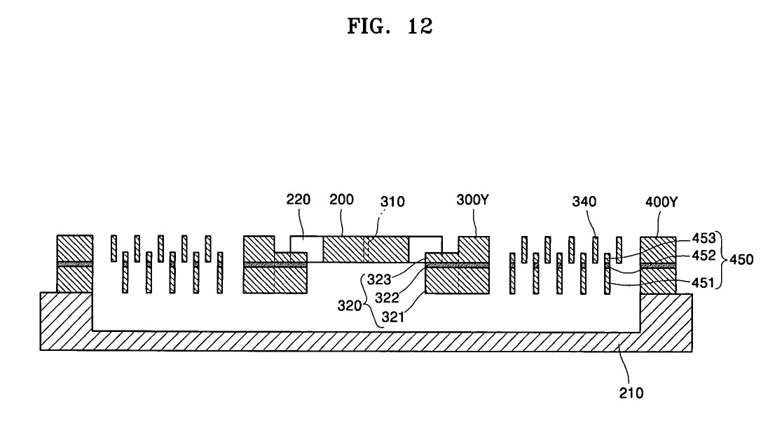

FIG. 10 is a perspective view of an actuator according to still another embodiment of the present invention. FIG. 11 is a plan view of the actuator of FIG. 10. FIG. 12 is a cross-sectional view taken along line XII-XII of FIG. 11.

Referring to FIGS. 10 through 12, a stage 200 is suspended above a substrate 210 made of Pyrex glass or the like by a first support unit that supports opposite sides of the stage 200.

The stage 200 is supported by the first support unit including first torsion springs 310 and a rectangular movable frame 300 such that the stage 200 can seesaw in a first direction (X direction). The first torsion springs 310 may be meander springs.

The first support unit is supported by a second support unit including second torsion springs 410 and a rectangular fixed frame 400 such that the first support unit can seesaw in a second direction (Y direction) perpendicular to the first direction. Accordingly, the stage 200 supported by the first support unit and the second support unit can move in two directions.

In detail, the stage 200 is connected to the rectangular movable frame 300 by the two first torsion springs 310 that extend in the second direction. Accordingly, the stage 200 is supported to seesaw about the first torsion springs 310.

The rectangular movable frame 300 includes two first portions 300X that are parallel to each other and extend in the first direction and two second portions 300Y that are parallel to each other and extend in the second direction. The first torsion springs 310 are respectively connected to centers of the first portions 300X and the second torsion springs 410 are respectively connected to centers of the second portions 300Y. The rectangular fixed frame 400 surrounds the rectangular movable frame 300. The rectangular fixed frame 400 includes two first portions 400X extending in the first direction, and two second portions 400Y extending in the second direction. The second torsion springs 410 connected to the centers of the second portions 300Y of the movable frame 300 are also connected to the centers of the second portions 400Y of the fixed frame 400. The second torsion springs 410 extend in the first direction. Accordingly, the movable fame 300 is supported to seesaw about the second torsion springs 410.

A stage driving unit causing the stage 100 to seesaw includes first driving comb electrodes 220 extending outward from the stage 200, and first fixed comb electrodes 320 extending from the movable frame 300 and alternating with the first driving comb electrodes 220. The comb electrodes are formed vertically.

The first fixed comb electrodes 320 include third fixed comb electrodes 321 lower in height than the first driving comb electrodes 220, insulation layers 322 formed on the third fixed comb electrodes 321, and fourth fixed comb electrodes 323 formed on the insulation layers 322 at a higher height than bottom surfaces of the first driving comb electrodes 220. Top surfaces of the fourth fixed comb electrodes 323 are lower than top surfaces of the first driving comb electrodes 220. The same voltage is applied to the third fixed comb electrodes 321 and the fourth fixed comb electrodes 323.

A first support unit driving unit is disposed between the movable frame 300 and the fixed frame 400. First extending members 330 are formed at opposite sides of the second torsion springs 410 extending from the second portions 300Y of the movable frame 300 toward the second portions 400Y of the fixed frame 400. Second driving comb electrodes 340 are formed on a side surface of the first extending members 330. Second extending members 440 extend from the fixed frame 400 and correspond to the first extending members 330. Second fixed comb electrodes 450 are formed on a side surface of the second extending members 440 facing the first extending members 330 and correspond to the second driving comb electrodes 340. The comb electrodes 340 and 350 alternate with each other as shown in FIG. 11.

The second fixed comb electrodes 450 include fifth fixed comb electrodes 451 lower in height than the second driving comb electrodes 340, insulation layers 452 formed on the fifth fixed comb electrodes 451, and sixth fixed comb electrodes 453 formed on the insulation layers 452 at a higher height than bottom surfaces of the second driving comb electrodes 340. Top surfaces of the sixth fixed comb electrodes 453 are lower than top surfaces of the second driving comb electrodes 340. The same voltage is applied to the fifth fixed comb electrodes 451 and the sixth fixed comb electrodes 453.

The stage 200, the first and second torsion springs 310 and 410, the first and second driving comb electrodes 220 and 340, the first extending members 330, and the fourth and sixth fixed comb electrodes 323 and 453 may be formed as an upper conductive layer of an SOI substrate, and the third and fourth fixed comb electrodes 321 and 451 may be formed as a lower conductive layer of the SOI substrate. The SOI substrate includes doped polysilicon layers and an insulation layer, e.g., an SiO₂ layer, disposed between the polysilicon layers.

When the biaxial actuator illustrated in FIGS. 10 through 12 is applied to a flat panel display, the stage driving unit can be used for a horizontal scanning, and the first support unit driving unit can be used for a vertical scanning. The driving unit including the multi-tiered fixed comb electrodes can have improved linearity during vertical scanning, and can also increase a driving force and a driving angle during horizontal scanning.

The operation of the actuator illustrated in FIGS. 10 through 12 is substantially the same as that of the actuator of FIGS. 4 through 6, and thus a detailed explanation thereof will not be given.

Since the actuator having the vertical comb electrode structure according to the present invention is configured such that the driving comb electrodes and the fixed comb electrodes overlap each other in the vertical plane, linear driving of the stage can be achieved. Also, the driving force can be increased, and thus the driving angle can be increased as well.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An actuator having a vertical comb electrode structure, the actuator comprising:
a stage seesawing in a first direction;
a support unit supporting the seesawing motion of the stage; and
a stage driving unit including vertical driving comb electrodes extending outward from opposite sides of the stage in the first direction, and vertical fixed comb electrodes disposed on a substrate to alternate with the driving comb electrodes,
wherein the fixed comb electrodes include first fixed comb electrodes lower than the driving comb electrodes, insulation layers formed on the first fixed comb electrodes, and second fixed comb electrodes formed on the insulation layers to be higher than bottom surfaces of the driving comb electrodes.

2. The actuator of claim 1, wherein top surfaces of the fixed comb electrodes are lower than top surfaces of the driving comb electrodes.

3. The actuator of claim 1, wherein the support unit comprises:
a pair of torsion springs extending from opposite sides of the stage in a second direction perpendicular to the first direction; and
a fixed frame fixing one end of each of the torsion springs to suspend the torsion springs above the substrate.

4. The actuator of claim 1, wherein the same voltage is applied to the first fixed comb electrodes and the second fixed comb electrodes.

5. The actuator of claim 1, wherein the driving comb electrodes and the second fixed comb electrodes are manufactured as a first conductive layer of a silicon-on-insulator (SOI) substrate, the first fixed comb electrodes are manufactured as a second conductive layer of the SOI substrate, and the SOI substrate further comprises an insulation layer interposed between the first conductive layer and the second conductive layer.

6. An actuator having a vertical comb electrode structure, the actuator comprising:
a stage suspended above a substrate and seesawing in a first direction;
a support unit supporting the seesawing motion of the stage; and
a stage driving unit including vertical driving comb electrodes extending outward from opposite sides of the stage in the first direction, and vertical fixed comb electrodes formed on the substrate to alternate with the driving comb electrodes,
wherein the driving comb electrodes include first driving comb electrodes higher than the fixed comb electrodes, insulation layers formed on bottom surfaces of the first driving comb electrodes, and second driving comb electrodes formed on the insulation layers to be lower than top surfaces of the fixed comb electrodes.

7. The actuator of claim 6, wherein bottom surfaces of the second driving comb electrodes are higher than bottom surfaces of the fixed comb electrodes.

8. The actuator of claim 6, wherein the support unit comprises:
a pair of torsion springs extending from opposite sides of the stage in a second direction perpendicular to the first direction; and
a fixed frame fixing one end of each of the torsion springs to suspend the torsion springs above the substrate.

9. The actuator of claim 6, wherein the same voltage is applied to the first driving comb electrodes and the second driving comb electrodes.

10. The actuator of claim 6, wherein the second driving comb electrodes and the fixed comb electrodes are manufactured as a first conductive layer of a silicon-on-insulator (SOI) substrate, the first driving comb electrodes are manufactured as a second conductive layer of the SOI substrate, and the SOI substrate further comprise an insulation layer interposed between the first conductive layer and the second conductive layer.

11. An actuator having a vertical comb electrode structure, the actuator comprising:
a stage seesawing in a first direction;
a first support unit supporting the stage;
a stage driving unit including first driving comb electrodes extending outward from opposite sides of the stage in the first direction, and first fixed comb electrodes formed on the first support unit facing the first driving comb electrodes to alternate with the first driving comb electrodes;
a second support unit supporting the first support unit so that the first support unit can seesaw in a second direction perpendicular to the first direction; and
a first support unit driving unit including second driving comb electrodes formed at the first support unit, and second fixed comb electrodes corresponding to the second driving comb electrodes,
wherein the second fixed comb electrodes include third fixed comb electrodes lower than the second driving comb electrodes, insulation layers formed on the third fixed comb electrodes, and fourth fixed comb electrodes formed on the insulation layers to be higher than bottom surfaces of the second driving comb electrodes.

12. The actuator of claim 11, wherein the first support unit comprises:
a pair of torsion springs extending from opposite sides of the stage in the second direction; and
a rectangular movable frame including a pair of first portions that are parallel to each other and are respectively connected to the first torsion springs, and a pair of second portions parallel to each other and extending in the second direction.

13. The actuator of claim 12, wherein the second support unit comprises:
a pair of second torsion springs extending from the second portions of the first support unit in the first direction; and
a rectangular fixed frame having a pair of second portions that are parallel to each other and are respectively connected to the second torsion springs, and a pair of first portions parallel to each other and extending in the first direction.

14. The actuator of claim 13, wherein the first support unit driving unit comprises:
first extending members that extend from the movable frame and are parallel to the second torsion springs; and
the second driving comb electrodes extending from the first extending members toward the first portions of the second support unit, and
the second fixed comb electrodes extend from second extending members which extend from the second support unit to correspond to the first extending members.

15. The actuator of claim 11, wherein top surfaces of the fourth fixed comb electrodes are lower than top surfaces of the second driving comb electrodes.

16. The actuator of claim 11, wherein the same voltage is applied to the third fixed comb electrodes and the fourth fixed comb electrodes.

17. The actuator of claim 11, wherein the first fixed comb electrodes include fifth fixed comb electrodes lower than the first driving comb electrodes, insulation layers formed on the fifth fixed comb electrodes, and sixth fixed comb electrodes formed on the insulation layers to be higher than bottom surfaces of the first driving comb electrodes.

18. The actuator of claim 17, wherein the first and second driving comb electrodes and the fourth and sixth fixed comb electrodes are manufactured as a first conductive layer of a silicon-on-insulator (SOI) substrate, the third and fifth fixed comb electrodes are manufactured as a second conductive layer of the SOI substrate, and the SOI substrate further comprises an insulation layer interposed between the first conductive layer and the second conductive layer.

19. An actuator having a vertical comb electrode structure, the actuator comprising:
a stage seesawing in a first direction;
a first support unit supporting the stage;
a stage driving unit including first driving comb electrodes extending outward extending from opposite sides of the stage in the first direction, and first fixed comb electrodes formed on the first support unit facing the first driving comb electrodes to alternate with the first driving comb electrodes;
a second support unit supporting the first support unit so that the first support unit can seesaw in a second direction perpendicular to the first direction; and
a first support unit driving unit including second driving comb electrodes formed at the first support unit, and second fixed comb electrodes corresponding to the second driving comb electrodes,
wherein the second driving comb electrodes include third driving comb electrodes higher than the second fixed comb electrodes, insulation layers formed on bottom surfaces of the third driving comb electrodes, and fourth driving comb electrodes formed on the insulation layers to be lower than top surfaces of the second fixed comb electrodes.

20. The actuator of claim 19, wherein the first support unit comprises:
a pair of torsion springs extending from opposite sides of the stage in the second direction; and
a rectangular movable frame including a pair of first portions that are parallel to each other and are respectively connected to the first torsion springs, and a pair of second portions parallel to each other and extending in the second direction.

21. The actuator of claim 20, wherein the second support unit comprises:
a pair of second torsion springs extending from the second portions of the first support unit in the first direction; and
a rectangular fixed frame including a pair of second portions that are parallel to each other and are respectively connected to the second torsion springs, and a pair of first portions parallel to each other and extending in the first direction.

22. The actuator of claim 21, wherein the first support unit driving unit comprises:
first extending members that extend from the movable frame and are parallel to the second torsion springs; and
the second driving comb electrodes extending from the first extending members toward the first portions of the second support unit, and
the second fixed comb electrodes extend from second extending members which extend from the second support unit to correspond to the first extending members.

23. The actuator of claim 19, wherein bottom surfaces of the fourth driving comb electrodes are higher than top surfaces of the second fixed comb electrodes.

24. The actuator of claim 19, wherein the same voltage is applied to the third driving comb electrodes and the fourth driving comb electrodes.

25. The actuator of claim 19, wherein the first driving comb electrodes include fifth driving comb electrodes higher than the first fixed comb electrodes, insulation layers formed on bottom surfaces of the fifth driving comb electrodes, and sixth driving comb electrodes formed on the insulation layers to be lower than top surfaces of the first fixed comb electrodes.

26. The actuator of claim 25, wherein the first and second driving comb electrodes and the fourth and sixth fixed comb electrodes are manufactured as a first conductive layer of a silicon-on-insulator (SOI) substrate, the third and fifth fixed comb electrodes are manufactured as a second conductive layer of the SOI substrate, and the SOI substrate further comprises an insulation layer interposed between the first conductive layer and the second conductive layer.
